(19) United States
(12) Patent Application Publication
(10) Pub. No.: US 2007/0183866 A1
(43) Pub. Date: Aug. 9, 2007

(54) Self locating wall fastener

(75) Inventor: James M. Gallien, Hidden Hills, CA (US)

Correspondence Address: STETINA BRUNDA GARRED & BRUCKER, 75 ENTERPRISE, SUITE 250, ALISO VIEJO, CA, 92656, US

(73) Assignee: Hangman Products, Inc.

(21) Appl. No.: 11/350,520

(22) Filed: Feb. 9, 2006

(51) Int. Cl. F16B 35/06

(52) U.S. Cl. 411/401

(57) ABSTRACT

An object hanging system is disclosed herein. The object hanging system may comprise an object fastener and a wall fastener engageable to the object fastener for hanging the object on the wall. The wall fastener may have a shank having an exterior surface with a thread formed thereon. The wall fastener may also have a collar attached to a proximal portion of the shank to regulate the insertion distance of the wall fastener into the wall. The wall fastener may also have a hook which directly engages the object fastener. The hook may be attached to the proximal side of the collar.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a fastener for hanging an object on a structure, and more particularly, to a fastener having a collar to regulate an insertion distance of the fastener into the structure.

Picture hanging devices come in many different types, sizes and shapes. Typically, the picture hanging device is a two part system. The first part may be a hook which is attached to a wall. The second part may be a frame fastener such as a sawtooth frame fastener which is attached to a frame. To hang the picture frame on a wall, the frame fastener is engaged to the hook.

Unfortunately, due to the construction of the hook, typically, the hook is inserted too deep into the wall such that the frame fastener cannot engage the hook. For example, a dry wall screw may be used as the hook. However, the dry wall screw may be inserted too deep into the wall such that a head of the dry wall screw is too close to the wall's exterior surface. In this instance, there is no space between the screw head and the exterior surface of the wall for the frame fastener to engage the hook. Conversely, due to the construction of the hook, the same may not be sufficiently inserted into the dry wall such that hanging an object from the hook may pull the hook out of the wall due to the weight of the object.

In another example, the hook may be a nail. Unfortunately, the nail is frequently hammered too far into the dry wall such that the head is flush with the exterior surface of the dry wall. In this instance, the frame fastener is incapable of being hung on the nail. The nail must be slightly retracted from the dry wall to provide a gap between the nail head and the wall's exterior surface. Unfortunately, retracting the nail from the dry wall has a detrimental effect of loosening the frictional engagement between the nail and the dry wall.

Alternatively, the nail head may be sufficiently gapped away from the dry wall exterior surface but may not be sufficiently inserted into the dry wall. In this instance, the pull out force—minimum force required to pull the nail out of the wall—may be less than the weight of the picture frame to be hung on the dry wall. As such, the picture frame will fall to the ground when hung on the nail.

Improvements have been made to conventional picture hanging devices. For example, an all girth-light drywall screw may be engaged to the drywall, as explained in U.S. Pat. No. 6,419,436 issued to Gaudron, the entire content of which is incorporated herein. The drywall screw has a helical thread with a pitch diameter of at least about twice the largest minimum diameter of a shank of the screw. Such configuration provides a stronger pull out force to prevent a weight of the object being hung from the wall from pulling out the screw. However, the screw may still be inserted into the dry wall too deep such that the head is flush with the dry wall exterior surface. Also, the screw may not be sufficiently inserted into the dry wall to prevent the screw from being pulled out of the dry wall when the picture frame is hung on the screw.

Accordingly, there is a need in the art for an improved picture hanging device.

### BRIEF SUMMARY

The self locating wall fastener discussed herein addresses the needs discussed above as well as the needs discussed below and those that are known in the art.

A system for hanging an object may be provided which may comprise a wall fastener and an object fastener. The wall fastener may have a shank defining a proximal portion and a distal portion. The shank may have threads formed thereon so as to engage a wall. The threads are formed between a collar attached to the shank proximal portion and an end of the shank. Also, a hook may be attached to a proximal side of the collar. The hook may include a head which is sized and configured to receive a tool for driving the threads into the wall. The hook may define a gap and a throat distance.

In use, the wall fastener is positioned on a wall. The tool drives the shank into the wall until the collar contacts the wall. In this manner, the insertion distance of the wall fastener is regulated by the collar. The collar prevents the wall fastener from being inserted into the wall too deep or too shallow. On one hand, if the wall fastener was inserted into the wall too deep, then there would be no “hook” to catch the frame fastener. On the other hand, if the wall fastener was insufficiently inserted into the wall, then the holding force of the wall fastener may not be sufficient to support the frame or object to be hung. Fortunately, the wall fastener includes a collar which stops insertion of the wall fastener into the wall before it is inserted into the wall too deeply. Also, once the collar contacts the wall, the installer may be sure that the wall fastener is sufficiently inserted into the wall such that the weight of the object to be hung does not pull out the wall fastener once the object is hung on the wall. Accordingly, the collar ensures that the hook is sufficiently exposed for engagement between the hook of the wall fastener and the frame fastener. Also, the collar ensures that a sufficient amount of threads are engaged to the wall such that a weight of the frame does not pull the wall fastener out of the wall once the frame is hung on the wall. Such a configuration permits do-it-yourselfers to install the wall fastener without damaging the wall or inserting the wall fastener too deep or too shallow into the wall.

The frame fastener may be attached to the frame to be hung on the wall. The frame fastener may be a wire, sawtooth, d-ring, or a key hole. The frame fastener, after being attached to the frame, may be hung on the wall fastener, and more particularly, seated on a seat of the hook.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a side view of a self locating wall fastener inserted into a drywall for hanging an object therefrom;

FIG. 2 is a front view of a self locating wall fastener illustrating a wire object fastener for hanging the object from the drywall;

FIG. 3 is a system level view of a keyhole attachable to the object and the self locating wall fastener attachable to the drywall wherein the keyhole engages the self locating wall fastener for hanging the object from the drywall;

FIG. 4 is a system level view of a sawtooth attachable to the object and the self locating wall fastener attachable to the drywall wherein the sawtooth engages the self locating wall fastener for hanging the object from the drywall;

FIG. 5 is a system level view of a D-hook attachable to the object and the self locating wall fastener attachable to the drywall wherein the D-hook engages the self locating wall fastener for hanging the object from the drywall; and

FIG. 6 is a partial cross sectional view of the self locating wall fastener of FIG. 1.

### DETAILED DESCRIPTION

An object hanging system 10 may be provided wherein an object 12 may be hung on a structure 14. The object hanging system 10 may comprise a structure fastener 16 which will hereinafter be referred to as a wall fastener and an object fastener which will hereinafter be referred to as a picture frame fastener 18. Although the object hanging system 10 will be discussed in relation to a picture frame 12 to be hung on a wall 14, the object hanging system 10 is not to be limited to such embodiment. Rather, the object hanging system 10 may be employed and embodied in other areas such as hanging objects from various structures such as ceilings, exterior and interior walls, other objects, and the like. Moreover, the object hanging system 10 may be employed and embodied to hang objects such as picture frames, diplomas, plants, artwork, etc. Accordingly, the embodiments and illustrations and descriptions provided herein for the object hanging system 10 are not meant to limit the object hanging system 10 to those embodiments and illustrations and descriptions expressed herein but are meant only for the purposes of illustration.

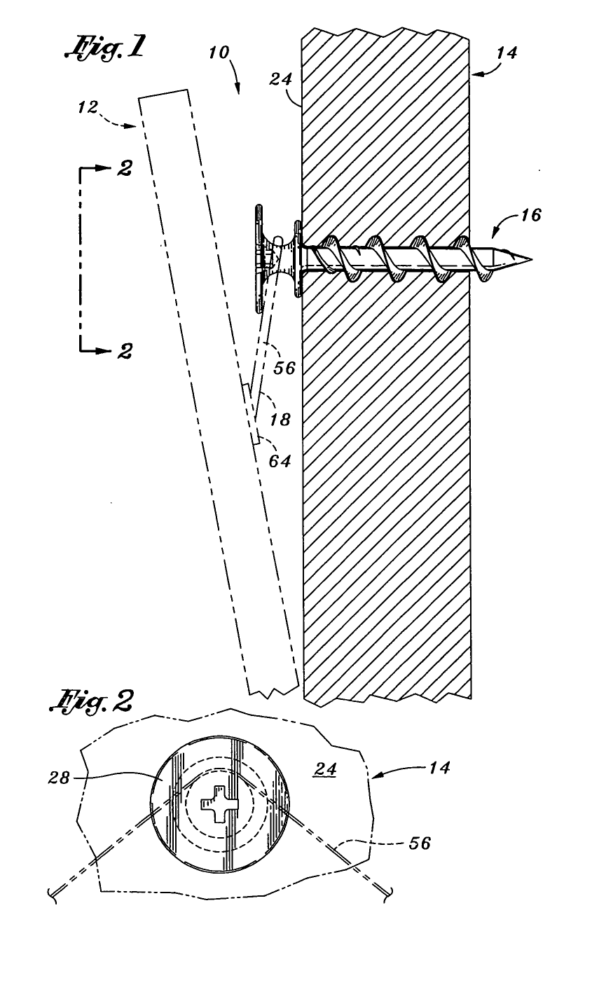

In use, the frame fastener 18 is fastened to a picture frame to be hung on a wall. The wall fastener 16 is then attached to the wall 14. The position of the wall fastener 16 on the wall 14 is selected by the installer to uniquely place the picture frame with respect to the various other decorations existing within the room or area. The frame fastener 18 is then engaged to the wall fastener 16 to hang the picture frame on the wall 14, as shown in FIG. 1.

To assist the installer installing the wall fastener 16, the wall fastener 16 may be fabricated with a collar 20 (see FIG. 6). The collar 20 is proximately located in front of the threads 22 to regulate the insertion distance of the wall fastener 16 into the wall 14. The collar 20 prevents the wall fastener 16 from being inserted too deeply or insufficiently (i.e., too shallow) into the wall 14. For example, the wall fastener 16 is threadingly engaged into the wall 14 until the exterior surface 24 of the wall 14 contacts a distal surface 26 of the collar 20, as shown in FIG. 1. In this manner, the installer is prevented from inserting the wall fastener 16 until a head 28 of the wall fastener 16 contacts the wall exterior surface 24 thereby leaving no room for the frame fastener 18 to engage the wall fastener 16. The collar 20 ensures that there is sufficient room for the frame fastener 18 to engage the wall fastener 16. Also, such configuration prevents the installer from inserting the wall fastener 16 into the wall 14 insufficiently (i.e., too shallowly). In other words, as shown in FIG. 1, four full revolutions of the thread 22 engages the wall 14. This provides a strong pull out force such that the weight of the object hung on the wall fastener 16 does not pull the wall fastener 16 out of the wall 14. However, if only one revolution of the thread 22 was inserted into the wall 14, then engagement or insertion of the wall fastener 16 may be too shallow or insufficient. This may provide insufficient pull out force such that the weight of the object to be hung on the wall fastener 16 will pull out the wall fastener 16 from the wall 14. Fortunately, the wall fastener 16 described herein includes a collar 20 which regulates the insertion distance of the wall fastener 16 into the wall 14 such that the wall fastener 16 is not inserted too deeply nor too shallowly into the wall 14.

As discussed above, the wall fastener 16 may have a collar 20. Additionally, the wall fastener 16 may also have a shank portion 30 with threads 22 formed about its exterior surface 32 extending about at least a portion of the length of the shank 30. The wall fastener 16 may also include a hook 34. More particularly, the wall fastener 16 may have a shank portion 30 with threads 22 formed about its exterior surface 32. The shank portion 30 may define a distal tip 36 and a proximal portion 38. The collar 20 may define a proximal side 38 and a distal side 26. The distal side 26 of the collar 20 may be fixedly or rotationally attached to the proximal portion 42 of the shank 30. Also, the hook 34 may be attached to the proximal side 38 of the collar 20. These three elements may be co-axially aligned with respect to each other and provide 360° symmetry about a rotating axis 40 of the wall fastener 16.

The distal side 26 of the collar 20 may be sized and configured to match the exterior surface 24 of the wall 14. For example, as shown in FIG. 1, the exterior surface 24 of the wall 14 is flat. Correspondingly, the distal surface 26 of the collar 20 is also flat. As such, when the wall fastener 16 is threaded into the wall 14, the insertion of the wall fastener 16 into the wall 14 is terminated when the distal side surface 26 of the collar 20 contacts the exterior surface 24 of the wall 14. Upon contact, the collar distal side 26 will slide gently against the wall exterior surface. Since the distal surface 26 of the collar 20 corresponds to the configuration of the exterior surface 24 of the wall 14, the collar 20 does not excessively mar or destroy the cosmetic appearance of the exterior surface 24 of the wall 14 which permits easy cosmetic repair of the wall 14 once the wall fastener 16 is removed from the wall 14, as will be further discussed in relation to the small shank diameter below.

As shown in FIGS. 2-5, the collar 20 may have a circular disc configuration having a thickness of about 0.035 inches and a diameter of about 0.314 inches. The distal side surface 26 of the collar 20 may also be perpendicularly aligned with the rotational axis 40 of the wall fastener 16. Moreover, a center of the collar 20 may also be aligned to the rotational axis 40. More broadly, the collar 20 may be any structure which prevents the threading engagement of the shank portion threads 22 into the wall 14. It is also contemplated within the scope, of this discussion that the collar 20 may have any configuration such as a pin, square, triangle, etc., and thus, the collar 20 is not to be construed as only limited to the circular disc configuration shown in the drawings.

The shank 30 may also be co-axially aligned to the rotating axis 40 of the wall fastener 16. The shank 30 may have an elongate cylindrical configuration having a constant diameter. Such portion may be referred to as the proximal portion 42 of the shank 30. The shank 30 may also have a reducing or tapered diameter which terminates at a tip. Such tapered portion is located on the shank 30 on the opposite side with respect to the collar 20. The tapered portion may hereinafter be referred to as the distal tip 36. The pointed distal tip 36 permits the installer to position the wall fastener 16 on the wall 14 and thread the wall fastener 16 into the wall 14 with or without drilling or pre-drilling a starter hole. Optionally, a pilot hole may be drilled into the wall 14 to lead the wall fastener 16 in the correct direction as the wall fastener 16 is threadingly engaged to the wall 14. The shank diameter may be approximately 0.124 inches. The shank length may be one and one quarter inches to about two and one quarter inches. The distal tip 36 may be approximately one quarter inch long and terminate in a pointed tip which is aligned to the rotational axis 40 of the wall fastener 16.

The shank 30 may have a high thread 44 and a low thread 46 formed on the exterior surface 32 of the shank 30. The high thread 44 may have an auger configuration. More particularly, the high and low threads 44, 46 may extend about the length of the shank 30 for about one and one quarter inches measured from the point of the shank distal tip 36 toward the collar 20. The entire exterior surface 32 of the shank 30 is not necessarily formed with threads 22. Rather, there may be a gap between the threads 22 and the distal surface 26 of the collar 20 where no threads are formed. For a matter of convenience, the threads 22 located adjacent to the collar 20 may be defined as the start, whereas the thread 22 located on the side of the distal tip 36 of the shank 30 may be defined as the terminal portion. The major diameter of the high thread 44 may be tapered at the start. In particular, the first one quarter revolution of the high thread 44 may be tapered by forming a thread 22 having a major diameter starting at about 0.124 inches and expanding to about 0.256 inches. The high thread 44 may then have a constant major diameter until the last 1½ revolution of the thread 22 at the terminal portion of the high thread 44. At the last 1½ revolution of the high thread 44, the major diameter of the high thread 44 may be tapered from about 0.256 inches to about 0.040 inches. This tapered thread allows the threads 22 to be easily started into the wall 14, effectively providing a tap. The low thread 46 may begin at the start and complete one revolution about the exterior surface 32 of the shank 30. The first one fourth revolution may be tapered with a major diameter starting at about 0.124 inches and expand to about 0.165 inches. The low thread 46 may continue with a constant major diameter of about 0.165 inches until the last quarter revolution. The last quarter revolution of the low thread 46 may be tapered with a major diameter of about 0.165 inches to about 0.124 inches.

The high and low threads 44, 46 may have a thread pitch of about 0.25 inches. The side profile of the thread 22 may have a triangular configuration with an angle 48 of about 40°, as shown in FIG. 6. Preferably, the pitch diameter of the high thread 44 may be at least twice the largest diameter of the shank 30. Alternatively, the pitch of the high thread 44 may be greater than the minor diameter of the high thread 44. The large ratio with respect to the thread 22 pitch and the major or minor thread diameters provide for a substantial amount of wall material between each revolution of the thread 22. Additionally, the thread major diameter may be much wider compared to the shank 30. The high ratio between the major diameter of the thread 22 and the outer diameter of the shank 30 also provides for a substantial amount of wall material to be engaged between each thread revolution. Also, it provides a large surface area for cutting into the wall 14. These ratios provide significant pull out resistance or force of the wall fastener 16. Also, the large ratio between the thread 22 major diameter and the shank 30 diameter leaves only a relatively small hole when the wall fastener 46 is removed which permits easy cosmetic repair of the wall 14.

This wall fastener 16 slices into the wall 14 and has a relatively small shank diameter compared with the major diameter. Thus, less of the dry wall is destroyed when the wall fastener 16 is threadingly engaged to the wall 14. So when the wall fastener 16 is removed from the wall 14, a much smaller hole to repair is left compared to conventional screws which permits easy cosmetic repair of the wall 14. The ratio of the major to minor diameters, and independently thereof, the ratio of the major diameter to the pitch, is preferably at least about 1.5:1, more preferably at least;about 1.75:1, and most preferably about 2:1 or more.

The hook 34 may be attached to the proximal side 38 of the collar 20, as shown in FIG. 6. The hook 34 may have a head 28 and a seat 50 which defines a throat distance 52 and a gap distance 54. The gap distance 54 determines the amount of room that the frame fastener 18 has to engage the hook 34. The throat distance 52 determines the amount of engagement of the frame fastener 18 to the hook 34. For example, if an earthquake were to occur, a deeper throat distance will permit the frame fastener 18 to remain engaged to the wall fastener 14. In use, as shown in FIG. 1, the frame fastener 18 shown is a wire device 56 wherein the wire 56 is looped over the head 28, inserted between the gap 54 through the throat distance 52 and seated on the seat 50 of the hook 34. As the frame 12 is shaken either through natural forces such as an earthquake or through inadvertent bumping by people, the frame fastener 18 remains securely on the wall fastener 16 because the head 28 prevents the frame fastener 18 from slipping off of the hook 34.

As shown in FIG. 6, the head 28 may have a circular disc configuration with a diameter of about 0.625 inches and a thickness of about 0.035 inches. The gap distance 54 may be about 0.188 inches and the throat distance 52 may be about 0.471 inches. The proximal side 58 of the head 28 may have a flat configuration as well as the distal side 60 of the head 28. The head 28 and the collar 20 may be parallel with respect to each other and coaxially aligned with respect to each other. The distal side surface 60 of the head 28 may also have a flat configuration. The seat 50 may have a curved concave configuration which is aligned to the distal side surface 60 of the head 28 and the proximal side surface 58 of the collar 20. The hook 34 may have a symmetrical configuration 3600 about the rotational axis 40 of the wall fastener 16. In this manner, despite the ultimate rotational orientation of the wall fastener 16 with respect to the wall 14 when the collar distal side 26 contacts the wall exterior surface, the frame fastener 18 is able to engage the hook 34 of the wall fastener 16. Also, due to the symmetrical configuration of the collar distal side 26 about 360° of the rotational axis 40 of the wall fastener 16, the distal side surface 26 of the collar 20 is able to smoothly engage the exterior surface 24 of the wall 14 despite the ultimate rotation orientation of the wall fastener 16 to the wall 14. It is also contemplated that the collar distal side 26 may be pitted for frictional engagement between the, wall exterior surface and the collar 20 distal side.

The proximal surface 58 of the head 28 may be formed with a cavity 62 sized and configured to receive a Phillips-type screwdriver. More particularly, the cavity 62 may have a cross-shaped configuration for receiving a #2 driver type 1 Phillips screwdriver. Although a Phillips-type recess is shown in the drawings, the wall fastener 16 is not to be limited to such configuration. It is contemplated that other types of cavities and protuberances may be formed on the distal side 60 of the head 28 so as to receive a driver tool. In use, the driver tool may be engaged to the head 28 of the wall fastener 16 to provide a rotational force to the wall fastener 16. The installer may align the distal tip 36 of the shank 30 to a point on the wall 14 at which the installer desires to engage the wall fastener 16 to the wall 14. The installer then rotates the wall fastener 16 with the driver tool. The threads 22 engage the wall 14. As the wall fastener 16 is rotated, the threads 22 advance into the wall 14. The installer stops rotating the wall fastener 16 into the wall 14 until the distal side surface 26 of the collar 20 contacts the exterior surface 24 of the wall 14.

The relative sizes and proportions of the wall fastener 16 discussed above are for the purposes of illustration only. Other sizes and proportions are also contemplated and are dependent upon the various sizes and applications of the frame and wall. Also, the type of wall (e.g., drywall concrete, etc.) would dictate the various sizes and proportions of the wall fastener 16. Similarly, the frame fastener 18 to be discussed may also be sized in accordance with the specific application in mind.

The wall fastener 16 may be fabricated from carbon steel but other materials are also contemplated such as plastics and the like.

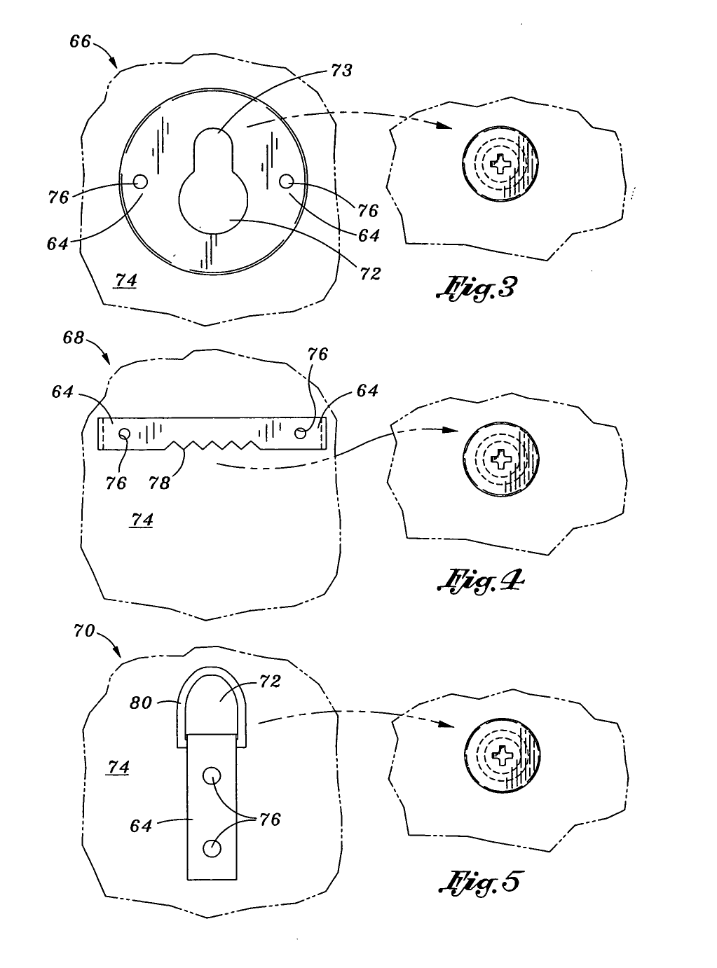

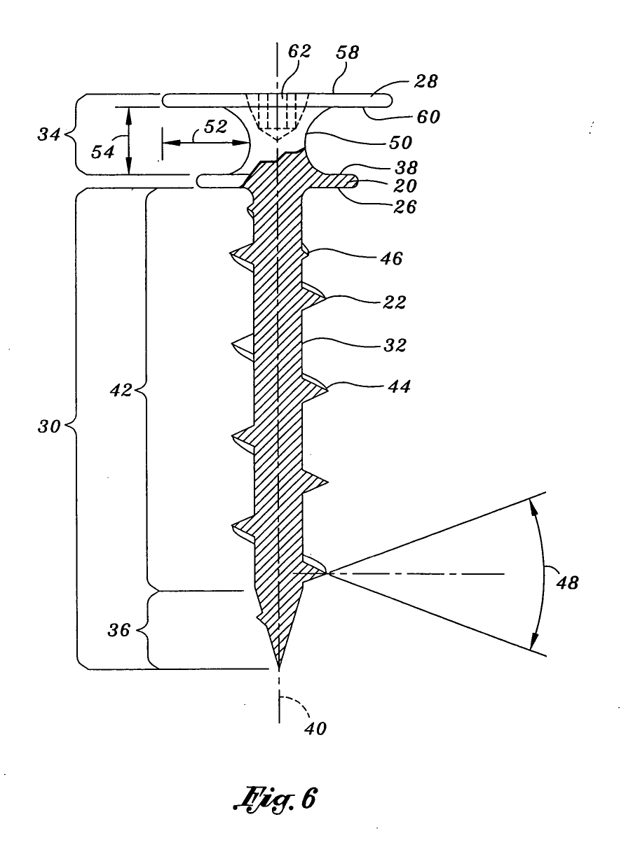

As shown in FIGS. 1 and 2, the frame fastener 18 may be a wire device 56. The wire device 56 has two lands 64 which are attachable to lateral sides of the picture frame 12. Sufficient slack is given to the wire 56 such that the wire 56 may be slung over the head 28 of the hook 34 and seated onto the seat 50, as shown in FIG. 2. The deep throat of the hook prevents the wire from slipping off of the hook 34 despite movement of the frame 12 with respect to the wall 14. Other types of frame fasteners are also contemplated which may be used in conjunction with the wall fastener 16 and engaged thereto. For example, in FIG. 3, a keyhole frame fastener 66 is shown. In FIG. 4, a sawtooth frame fastener 68 is shown. In FIG. 5, a d-ring frame fastener 70 is shown.

Referring now to FIG. 3, the keyhole frame fastener 66 has land portions 64 laterally disposed about a primary aperture 72 and a secondary aperture 73. The primary aperture 72 and the secondary aperture 73 are stepped or gapped away from the backside 74 of the picture frame 12, whereas the land portions 74 are stepped down to engage the backside of the picture frame 12. Fastening holes 76 are formed at the land portions 64 which are sized and configured to receive a nail or a screw to attach the keyhole frame fastener 18 to the backside 74 of the picture frame 12. The primary aperture 72 may have a circular configuration having a diameter greater than that of the diameter of the head 28. The secondary aperture 73 may have a slotted configuration having a width greater than that of the seat 50 of the hook 34 but smaller than the head diameter. In use, the wall fastener 16 is engaged to the wall 14, and the keyhole frame fastener 66 is engaged above the center of gravity of the picture frame 12. The primary aperture 72 is aligned to the head 28 and the head 28 is inserted into the primary aperture 72. Thereafter, the frame 12 is lowered such that the secondary aperture 73 is seated onto the seat 50 of the hook 34. Since the diameter of the head 28 is larger than the width of the secondary aperture 73, the picture frame 12 is securely attached to the wall 14. To remove the picture frame 12 from the wall 14, the picture frame 12 is lifted such that the head 28 is aligned to the primary aperture 72. Thereafter, the head 28 is removed from the primary aperture 72 thereby removing the picture frame 12 from the wall 14.

Referring now to FIG. 4, a sawtooth frame fastener 68 is shown. The sawtooth frame fastener 68 may have a jagged lower edge 78 with lands 64 disposed laterally thereabout. The lands 64 may have fastening apertures 76 formed therethrough for receiving a nail or screw to attach the sawtooth frame fastener 68 to the backside 74 of the picture frame 12. The sawtooth lower edge 78 may be gapped away from the backside 74 of the picture frame 12 to permit the head 28 of the hook 34 to be inserted between the sawtooth lower edge 78 and the backside 74 of the picture frame 12. In this manner, vertical movement of the picture frame 12 with respect to the walls 14 is prevented. The sawtooth lower edge 78 is then seated onto the seat 50 of the hook 34. The jagged configuration of the sawtooth lower edge 78 prevents lateral movement of the picture frame 12 with respect to the wall 14. The seat 50 preferably resides within one of the valleys of the lower sawtooth edge 78.

Referring now to FIG. 5, a d-ring frame fastener 70 is shown. The d-ring frame fastener 70 may comprise a d-ring 80 with a land 64 attached thereto. The d-ring 80 may be fabricated from a plastic or metallic material and have a d-shaped configuration. A bottom portion of the d-ring 80 may have a flexible member or land 64 attached thereto. The flexible member may have two fastening apertures 76 formed therethrough. The fastening apertures 76 are sized and configured to receive a nail or screw therethrough to permit fastening of the d-ring frame fastener 70 to a backside 74 of the picture frame 12. The d-ring 80 and the flexible strap may be rotated with respect to each other. The d-ring 80 may define a primary aperture 72 which is sized and configured to fit over the head 28 of the hook 34 of the wall fastener 16. In use, the wall fastener 16 is attached to the wall 14, and the d-ring frame fastener 70 is attached to the backside 74 of the picture frame 12. More particularly, the d-ring 80 is aligned to the center of gravity of the picture frame 12 and located thereabove. The head 28 is inserted through the primary aperture 72 of the d-ring 80, and the picture frame 12 is gently lowered. Once lowered, an inner surface of the d-ring 80 contacts the seat 50 of the hook 34 to securely engage the picture frame 12 to the wall 14 and the d-ring wall to the wall fastener 16. To remove the picture frame 12 from the wall 14, the picture frame 12 is slightly lifted. Thereafter, the d-ring 80 is removed from the hook 34, and the picture frame 12 is thereby removed from the wall 14.

In another embodiment, a method of hanging a picture frame 12 to the wall 14 is disclosed. In the method, a wall fastener 16 may be engaged to a wall 14, a picture frame fastener 18 may be engaged to a picture frame 12, and the picture frame fastener 18 may be engaged to the wall fastener 16 to hang the picture frame 12 to the wall 14. More particularly, in the attaching step, the wall fastener 16 may be inserted or threadingly engaged to the wall 14 until a distal surface 25 of a collar 20 of the wall fastener 16 contacts the exterior surface 24 of the wall 14 to regulate the insertion distance of the wall fastener 16 into the wall 14.

The above description is given by way of example, and not limitation. Given the above disclosure, one skilled in the art could devise various variations that are within the scope and spirit of the invention disclosed herein. Further, the various features of the embodiments disclosed herein can be used alone, or in varying combinations with each other and are not intended to be limited to the specific combinations described herein. Thus, the scope of the claims is not to be limited by the illustrated embodiments.

What is claimed is:

1. A device for hanging an object on a structure, the device comprising:
a shank having a thread formed thereon for engagement into the wall;
a collar attached to the shank for regulating an insertion distance of the device into the wall; and
a hook attached to the collar for engaging the object.

2. The device of claim 1 wherein a diameter of a proximal portion of the shank is constant, and a major diameter of the thread formed on the proximal portion is constant.

3. The device of claim 1 wherein a diameter of a distal portion of the shank is tapered and a major diameter of the thread formed on the distal portion is tapered.

4. The device of claim 1 wherein the thread is a helical thread with a pitch diameter of at least about twice the diameter of a proximal portion of the shank.

5. The device of claim 1 wherein the thread has a geometry of an auger.

6. The device of claim 1 wherein the collar is spaced apart from the head for receiving the object.

7. The device of claim 1 wherein the hook has a head adapted to be engaged by a driving tool.

8. The device of claim 7 wherein the head has a cavity adapted for receiving a Phillips-type screw driver.

9. A system for hanging an object on a wall, the system comprising:
a first hanging device attachable to the object; and
a second hanging device attachable to the wall, the second hanging device comprising:
a shank having a thread formed thereon for engagement into the wall;
a collar attached to the shank for regulating an insertion distance of the second hanging device into the wall; and
a hook attached to the collar for engaging the first hanging device.

10. The system of claim 9 wherein the first hanging device is a wire.

12. The system of claim 9 wherein the first hanging device is a keyhole fastener.

13. The system of claim 9 wherein the first hanging device is a D-ring.

14. The system of claim 9 wherein the first hanging device is a sawtooth.
